(19) United States
(12) Patent Application Publication
(10) Pub. No.: US 2025/0036327 A1
(43) Pub. Date: Jan. 30, 2025

(54) NON-TRANSITORY COMPUTER-READABLE RECORDING MEDIUM STORING COMPUTER-READABLE INSTRUCTIONS FOR TERMINAL DEVICE, METHOD FOR CONTROLLING TERMINAL DEVICE, AND TERMINAL DEVICE

(71) Applicant: BROTHER KOGYO KABUSHIKI KAISHA, Nagoya (JP)

(72) Inventor: Kenju NARITA, Nagoya (JP)

(21) Appl. No.: 18/781,482

(22) Filed: Jul. 23, 2024

(30) Foreign Application Priority Data
Jul. 28, 2023 (JP) 2023-123278

(51) Int. Cl. G06F 3/12

(52) U.S. Cl. CPC G06F 3/1207; G06F 3/121; G06F 3/1234; G06F 3/1286

(57) ABSTRACT

A computer-readable instructions for a terminal device may be provided, in which the computer-readable instructions, when executed by a processor of the terminal device, cause the terminal device to obtain flag information related to a first communication device, wherein the flag information indicates either a first value or a second value, cause a display unit to display a first screen, wherein in a case where the flag information indicates the first value, the first screen including a first object related to the first communication device is displayed, and in a case where the flag information indicates the second value, the first screen not including the first object is displayed, and in a case where the first object included in the first screen is operated by a user, execute a first process for sending related information related to the first communication device to an external device.

### REFERENCE TO RELATED APPLICATION

This application claims priority from Japanese Patent Application No. 2023-123278 filed on Jul. 28, 2023. The entire content of the priority application is incorporated herein by reference.

### BACKGROUND ART

A technique that sends print log information to an external device is known. In this technique, a host computer accepts registration of an email address in a print setting dialog. Then, upon when printing is completed or when an error occurs, a printer sends an email using the registered email address as a recipient. Further, it is also known that the host computer may be caused to display a message for inquiring a user whether to send the email upon completion of the printing or occurrence of the error.

### SUMMARY

In the description herein, a novel technology configured to send related information related to a communication device to an external device is disclosed.

A non-transitory computer-readable recording medium storing computer-readable instructions for a terminal device is disclosed herein. The computer-readable instructions, when executed by a processor of the terminal device, may cause the terminal device to: obtain flag information related to a first communication device, wherein the flag information indicates either a first value or a second value; in a case where a predetermined condition is satisfied, cause a display unit of the terminal device to display a first screen, wherein in a case where the flag information related to the first communication device indicates the first value, the first screen including a first object related to the first communication device is displayed, and in a case where the flag information related to the first communication device indicates the second value, the first screen not including the first object is displayed; and in a case where the first object included in the first screen is operated by a user, execute a first process for sending related information related to the first communication device to an external device.

According to the above configuration, the terminal device displays the first screen in the case where the predetermined condition is satisfied. In the case where the flag information indicates the first value, the first screen includes the first object. In a case where the first object is selected by the user, the terminal device executes the first process and thus can send the related information related to the first communication device to an external device. On the other hand, in the case where the flag information indicates the second value, the first screen does not include the first object. As above, a novel technology configured to send related information related to a first communication device to an external device is realized.

A computer-readable recording medium storing the computer-readable instructions as above, a terminal device realized by the computer-readable instructions as above, and a method for controlling the terminal device are also novel and useful.

### BRIEF DESCRIPTION OF DRAWINGS

FIG. 1 is a configurational diagram of a communication system.

FIG. 2 is a flowchart of processes executed by a management application.

FIG. 3 is a sequence diagram of processes executed between respective devices.

FIG. 4 is a sequence diagram of Case A-1 and Case A-2.

FIG. 5 is a sequence diagram of Case B-1 and Case B-2.

FIG. 6 is a sequence diagram of Case C.

### DESCRIPTION

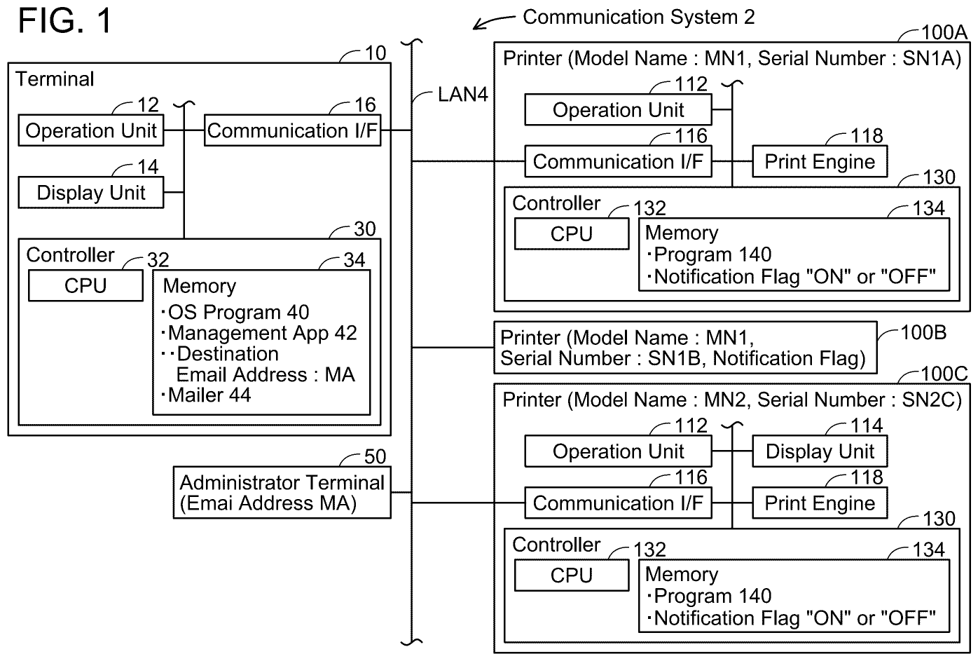

### (Configuration of Communication System 2; FIG. 1)

As shown in FIG. 1, a communication system 2 comprises a terminal 10, an administrator terminal 50, and a plurality of printers 100A to 100C. Each of these devices 10, 50, 100A to 100C is connected to a Local Area Network (LAN) 4. The LAN 4 may be a wired LAN or a wireless LAN. In the description herein, a technology for the terminal 10 to send information related to respective printers 100A to 100C to the administrator terminal 50 is disclosed.

### (Configuration of Terminal 10)

The terminal 10 is a terminal device, which may be a stationary PC, a laptop PC, a portable phone, a smartphone, a PDA, or a tablet PC. The terminal 10 comprises an operation unit 12, a display unit 14, a communication interface 16, and a controller 30. The respective units 12 to 30 are connected to a bus line. Hereinbelow, an interface may be denoted as “I/F”.

The operation unit 12 is an I/F that allows a user to input various information to the terminal 10, and may for example comprise a touch screen and/or buttons. The user can thus input various information to the terminal 10 using the operation unit 12. The display unit 14 is a display configured to display various information. The communication I/F 16 s connected to the LAN 4.

The controller 30 comprises a CPU 32 and a memory 34. The memory 34 comprises a primary storage device and a secondary storage device. The primary storage device includes a RAM and a cache memory, for example. The secondary storage device may include a flash memory, a Solid State Drive (SSD), or a ROM, or may be a combination thereof. An OS program 40, a management application program 42, and a mailer program 44 are stored in the secondary storage device. The CPU 32 realizes respective processes in accordance with respective programs 40 to 44 loaded from the secondary storage device onto the primary storage device. Hereinbelow, the OS program 40, the management application program 42, and the mailer program 44 will respectively be termed “OS 40”, “management application 42”, and “mailer 44”.

The OS 40 controls basic operations of the terminal 10. The management application 42 manages a plurality of management target devices including the printers 100A to 100C. The management application 42 stores a recipient email address MA, which is a recipient of an email including information related to a printer. As this will be described later, the recipient email address MA is an email address set in the administrator terminal 50 (i.e., an email address of an administrator). The mailer 44 sends and receives emails.

### (Configuration of Administrator Terminal 50)

The administrator terminal 50 is a terminal device, which may be a stationary PC, a laptop PC, a portable phone, a smartphone, a PDA, or a tablet PC. The email address MA is set in the administrator terminal 50.

### (Configuration of Printer 100A)

The printer 100A is a peripheral device capable of performing a printing function. Thus, the printer 100A is, for example, a peripheral device of the terminal 10. In a modification, for example, the printer 100A may be a multifunction peripheral capable of performing a scan function and a facsimile function in addition to the printing function. The printer 100A is a model with a model name MN1. The printer 100A is assigned with a serial number SNIA, being information for identifying the printer 100A. The printer 100A comprises an operation unit 112, a communication I/F 116, a print engine 118, and a controller 130. The respective units 112 to 130 are connected to a bus line. As described above, the printer 100A being a model with the model name MN1 does not have a display (i.e., display unit).

The operation unit 112 is an interface that allows the user to input various information to the printer 100A, and may for example comprise a touch screen and/or buttons. The user can input various information to the printer 100A using the operation unit 112. The communication interface 116 is connected to the LAN 4. The print engine 118 includes an inkjet, laser, or thermal printing mechanism.

The controller 130 comprises a CPU 132 and a memory 134. The memory 134 comprises a primary storage device and a secondary storage device. The primary storage device includes a RAM and a cache memory, for example. The secondary storage device may include a flash memory, a Solid State Drive (SSD), or a ROM, or may be a combination thereof. A program 140 is stored in the secondary storage device. The CPU 32 realizes respective processes in accordance with the program 140 loaded from the secondary storage device onto the primary storage device.

The memory 134 further stores a notification flag. The notification flag indicates either “ON”, which corresponds to a case in which related information related to the printer 100A is to be sent to an external device (in the present embodiment, to the administrator terminal 50), or “OFF”, which corresponds to a case in which the related information is not to be sent to an external device. The external device may be a server. The server may be a physical server, or a virtual server. The server may be a cloud server or a server on an intranet. In a situation where a paid service for sending related information is used by the printer 100A, the notification flag indicates “ON”. On the other hand, in a situation where the above service is not used by the printer 100A, the notification flag indicates “OFF”.

### (Configuration of Printer 100B)

The configuration of the printer 100B is the same as that of the printer 100A except that it is given a serial number SN1B. That is, printer 100B also does not include a display.

### (Configuration of Printer 100C)

The printer 100C is a model with a model name MN2. The printer 100C is assigned with a serial number SN2C. The printer 100C comprises a display unit 114 in addition to respective units 112 and 116 to 140 of the printer 100A. The display unit 114 is a display for displaying various information. That is, the printer 100C being a model with the model name MN2 includes a display (i.e., display unit 114).

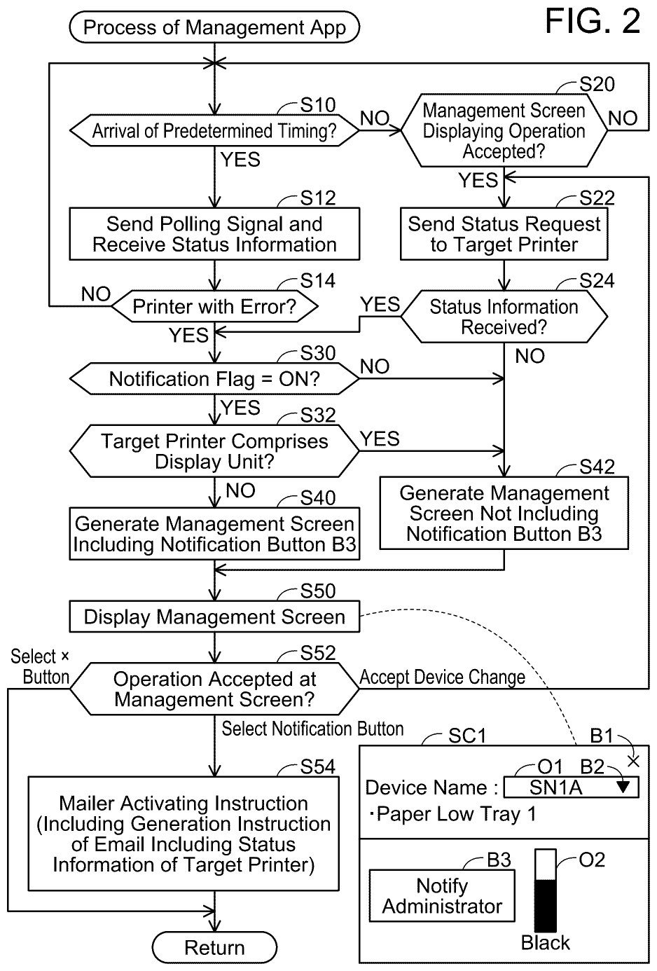

### (Processes by Management Application 42; FIG. 2)

Next, with reference to FIG. 2, processes realized by the CPU 32 of the terminal 10 executing the management application 42 will be described. The management application 42 is activated as a background program when the terminal 10 is turned on. The management application 42 starts the process of FIG. 2 with being started in the background (i.e., by the terminal 10 being started) as its trigger.

In S10, the CPU 32 monitors an arrival of a predetermined timing. The predetermined timing is, for example, a time point when a predetermined time (e.g., 5 minutes) elapses since the previous S12 process. Further, the CPU 32 may also determine that the predetermined timing has arrived when the process of S12 has not yet been executed even once since the management application 42 was activated.

In S12, the CPU 32 sends a polling signal to each of the plurality of printers to be managed (printers 100A to 100C in the present embodiment) via the communication I/F 16 and receives, from each of the plurality of printers, status information indicating a status of that printer. The management application 42 stores information (e.g., IP address, node name, etc.) for sending the polling signal to each of the plurality of printers to be managed. The status information includes the model name and serial number of the sender printer, remaining amount information indicating remaining amount(s) of coloring material(s) in coloring material cartridge(s) installed in the sender printer, and the notification flag of the sender printer. The status information includes error information indicating an error (e.g., paper jam, paper runout, coloring material runout, non-installation error of coloring material cartridge, or communication error), in a case where an error is occurring in the sender printer. In a modification, the status information may include, in addition to the above information, information indicating a communication status of the printer, information indicating a usage history (e.g., cumulative number of sheets printed) of the printer, and other information of the printer, for example.

In S14, the CPU 32 determines whether or not a printer that is experiencing an error exists. Specifically, the CPU 32 determines whether or not status information including the error information was received among the status information received in S12. In a case where no status information including the error information is received, the CPU 32 determines NO to S14 and returns to the monitoring process in S10. On the other hand, in a case where the status information including the error information is received, the CPU 32 determines YES to S14 and proceeds to S30. In the following, the status information including the error information and the printer from which this status information was sent will be described as “target status information” and “target printer,” respectively.

In S20, the CPU 32 monitors whether a management screen display operation is accepted from the user. This operation is an operation for causing the management screen generated by management application 42 to be displayed, and for example, it is an operation to select a management application 42 icon. As this will be described in detail below, when the management application 42 receives such an operation, it displays the management screen. As such, this operation can be said to be an operation to make the management application 42, which operates in the background, operate in foreground. In a case where the CPU 32 determines that this operation was accepted from the user (YES to S20), it proceeds to S22. On the other hand, when the CPU 32 determines that the operation was not accepted (NO to S20), it returns to the monitoring process in S10.

In S22, the CPU 32 sends a status request to one specific printer via the communication I/F 16. Here, “one specific printer” in the case of YES to S20 is the printer designated as a default printer. In addition, as this will be described in detail below, the “specific one printer” in the case of “Accept Device Change” in S52 is a printer identified by the serial number designated by the user. Hereinafter, the above specific printer is also referred to as “target printer”.

In S24, the CPU 32 determines whether or not the status information was received from the target printer via the communication I/F 16. In a case of receiving the status information from the target printer (YES to S24), the CPU 32 proceeds to S30. Hereinafter, the status information received from the target printer is also referred to as “target status information”. On the other hand, in a case where no status information is received from the target printer even after a predetermined time has elapsed from the process in S22, the CPU 32 determines NO to S24 and proceeds to S42.

In S30, the CPU 32 determines whether the notification flag of the target printer indicates ON or OFF. Specifically, the CPU 32 determines whether the notification flag in the target status information indicates ON or OFF. The CPU 32 proceeds to S32 in a case where the notification flag indicates ON (YES to S30) and proceeds to S42 in a case where the notification flag indicates OFF (NO to S30).

In S32, the CPU 32 determines whether the target printer has a display unit or not. Specifically, the CPU 32 identifies the model name in the target status information. Here, for each of the plurality of model names, the terminal 10 stores information indicating whether the printer with that model name is a model with a display unit or a model without a display unit. The CPU 32 determines whether the target printer has a display unit or not based on the model name in the target status information and the above information. In a case where the CPU 32 determines that the target printer does not have a display unit (NO to S32), it proceeds to S40, and in a case where it determines that the target printer has a display unit (YES to S32), it proceeds to S42.

In S40, the CPU 32 generates a management screen including a notification button B3. Specifically, the CPU 32 arranges a “close” button B1, a device selection object O1, a remaining amount object O2, and the notification button B3 on the management screen. The “close” button B1 is a button to end the display of the management screen. The device selection object O1 is an object for accepting user's selection of the serial number that identifies the printer to be managed, and includes a button B2. By selecting the button B2 in the device selection object O1, the user can select one serial number among a plurality of serial numbers. At a timing when the management screen is generated, the serial number of the target printer is described in the device selection object O1. The remaining amount object O2 is an object indicating the remaining amount information included in the target status information. Due to this, by looking at the management screen, the user can acknowledge the remaining amount(s) of coloring material(s) in the coloring material cartridge(s) installed in the target printer. A management screen SC1 in FIG. 2 includes a remaining amount object O2 for the remaining amount of the coloring material “black”, however, it may also include, in addition to or instead of the above, remaining amount object(s) for other color(s) (e.g., “cyan”, “magenta”, “yellow”). The notification button B3 is a button for sending related information related to the target printer to the administrator. Further, in a case where the target status information includes error information, the CPU 32 arranges information indicating the content of the error indicated by the error information (in the example in FIG. 2, the character string “Paper Low Tray 1”) on the management screen. Due to this, by looking at the management screen, the user can acknowledge the error that has occurred in the target printer.

In S42, the CPU 32 generates a management screen that does not include the notification button B3. The specific process is the same as the process in S40, except that a screen that does not include the notification button B3 is generated. In S42 following NO to S24, the CPU 32 may generate a management screen that includes information (e.g., character string “offline”) indicating that the status information has not been received from the target printer instead of the remaining amount object O2.

In S50, the CPU 32 causes the display unit 14 to display the management screen that has already been generated in S40 or S42.

In S52, the CPU 32 monitors that an operation is accepted in the management screen. The CPU 32 returns to the monitoring process of S10 in a case where the “close” button B1 is selected (“Select X Button” in S52). In a case where the button B2 in the device selection object O1 is selected and then one serial number is selected (“Accept Device Change” in S52), the CPU 32 proceeds to S22. The CPU 32 also proceeds to S54 when the notification button B3 is selected (“Select Notification Button” in S52).

In S54, the CPU 32 supplies a mailer activating instruction to the mailer 44. This activating instruction includes an instruction to generate an email including the status of the target printer. This generation instruction includes the stored recipient email address MA. As a result, although details will be described later, the mailer 44 generates an email with the administrator email address MA as a recipient and including the status of the target printer, and sends the email to the administrator terminal 50.

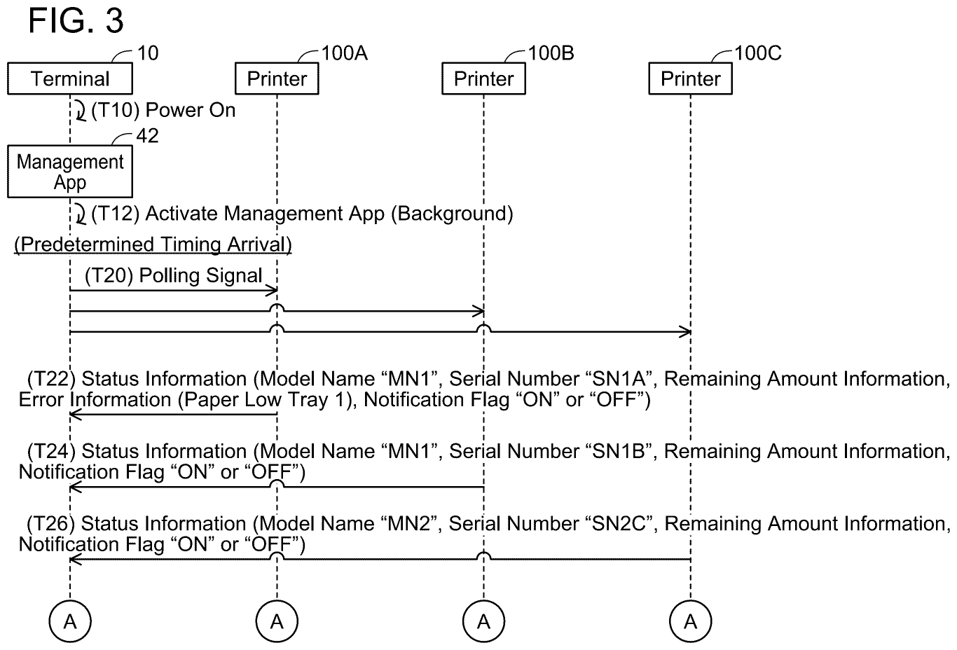

(Processes Executed between Devices; FIG. 3)

Processes executed between the devices will be described with reference to FIG. 3. For easier understanding, the processes executed by the CPUs (e.g., 32, 132) of each device (e.g., terminal 10, printers 100A to 100C) are described below with the devices as the subject of action instead of describing them with the CPUs as the subject of action. Especially, when describing a process realized by the CPU 32 executing the management application 42, the management application 42 will be described as the subject of action. Similarly, when describing a process realized by the CPU 32 executing the mailer 44, the mailer 44 will be described as the subject of action. In addition, communication between the devices is performed via communication I/Fs (e.g., 16, 116). Therefore, in the following explanations, “via communication I/F” will be omitted when describing the communication.

In T10, an operation to turn on the power of the terminal 10 is performed. In this case, in T12, the management application 42 is activated in the background (trigger in FIG. 2). The management application 42 executes the monitoring process of S10 and S20 in FIG. 2 until a predetermined timing arrives.

Then, when the predetermined timing arrives (YES to S10 in FIG. 2), the management application 42 sends a polling signal to each of the plurality of printers 100A to 100C in T20 (S12).

When the printer 100A receives the polling signal from the terminal 10 in T20, it sends status information to the terminal 10 in T22. This status information includes the model name “MN1”, the serial number “SNIA”, the remaining amount information, the error information “Paper Low Tray 1”, and the notification flag.

When the printer 100B receives the polling signal from the terminal 10 in T20, it sends its status information to the terminal 10 in T24. The status information includes the model name “MN1”, the serial number “SN1B”, the remaining amount information, and the notification flag.

When the printer 100C receives the polling signal from the terminal 10 in T20, it sends its status information to the terminal 10 in T26. The status information includes the model name “MN2”, the serial number “SN2C”, the remaining amount information, and the notification flag.

The management application 42 receives the status information from each of the printers 100A to 100C in T22 to T26 (S12). In this case in particular, the management application 42 receives the status information including the error information from the printer 100A (YES to S14).

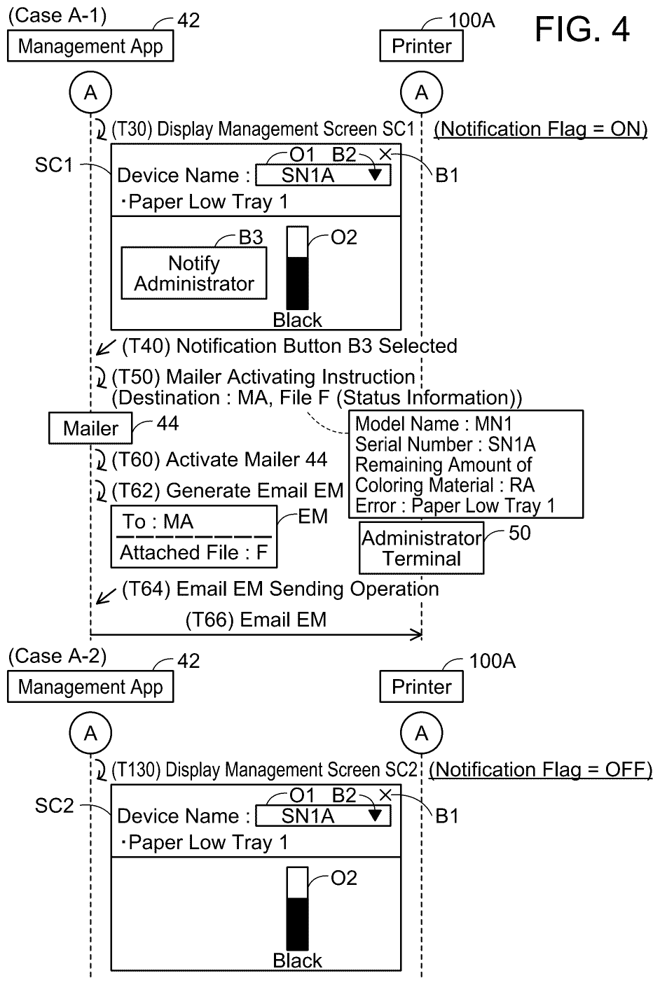

### (Case A-1; FIG. 4)

First, Case A-1 in which the notification flag of the printer 100A indicates “ON” will be described with reference to FIG. 4. Case A-1 is a continuation of FIG. 3. In Case A-1, the management application 42 receives the status information including the error information and the notification flag “ON” from the printer 100A in T22 in FIG. 3 (YES to S14 and YES to S30 in FIG. 2). Based on the model name “MN1” included in the status information already received from the printer 100A, the management application 42 determines that the printer 100A does not have a display unit (NO to S32). In this case, the management application 42 generates the management screen SC1 including the notification button B3 (S40) and causes the display unit 14 to display the generated management screen SC1 in T30 (S50).

In T40, the management application 42 accepts a selection of the notification button B3 in the management screen SC1 from the user (“Select Notification Button” in S52). In this case, the management application 42 generates a file F (e.g., a text file) representing the received status information. Then, in T50, the CPU 32 supplies a mailer activating instruction to the mailer 44 to activate the mailer 44. The mailer activating instruction includes an instruction for generating an email including the stored recipient email address MA and the generated file F. The file F includes the model name “MN1”, the serial number “SN1A”, the remaining amount of coloring material “RA” indicated by the remaining amount information, and the error “Paper Low Tray 1” included in the received status information.

When the mailer activating instruction is supplied by the management application 42 in T50, the mailer 44 is activated in T60. Then, in T62, the mailer 44 generates an email EM according to the email generation instruction included in the mailer activating instruction. The email EM includes the recipient email address MA as the destination address and the file F as an attachment.

When the mailer 44 receives a sending operation (e.g., selection of “send” button not shown) from the user in T64, it sends the email EM to the email address MA (i.e., the administrator terminal 50) as its recipient in T66. The administrator can check the status of the printer 100A by looking at the file F attached to the email EM. In this case, the administrator can acknowledge that there is an error occurring in the printer 100A.

### (Case A-2; FIG. 4)

Next, Case A-2 in which the notification flag of the printer 100A indicates “OFF” will be described with reference to FIG. 4. Case A-2 is a continuation of FIG. 3. In Case A-2, in T22 in FIG. 3 (YES to S14 and NO to S30 in FIG. 2), the management application 42 receives status information including error information and including the notification flag “OFF” from the printer 100A. In this case, the management application 42 generates a management screen SC2 that does not include the notification button B3 (S42), and causes the display unit 14 to display the generated management screen SC2 in T130 (S50). The management screen SC2 is the same as the management screen SC1 except that it does not include the notification button B3. As described above, when the notification flag indicates “OFF,” the user cannot use the service for sending related information related to the printer 100A. As such, the unnecessary button B3 is suppressed from being displayed.

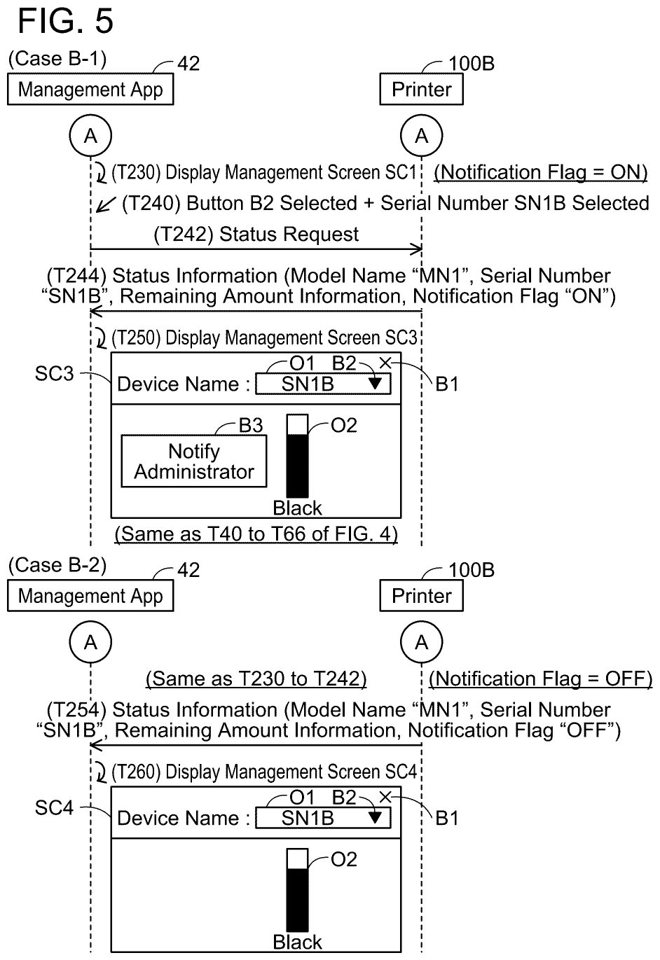

### (Case B-1; FIG. 5)

Next, a case in which the serial number SN1B of the printer 100B is selected in the device selection object O1 in the management screen (e.g., SC1) will be described. First, Case B-1 in which the notification flag of the printer 100B indicates “ON” will be described with reference to FIG. 5. Case B-1 is a continuation of FIG. 3. Process of T230 is the same as the process of T30 in FIG. 4.

In T240, the management application 42 accepts the selection of the button B2 of the device selection object O1 in the management screen SC1. In this case, a selection screen (not shown) including serial numbers of plural printers to be managed (i.e., three serial numbers SN1A, SN1B, and SN2C in this case) is displayed. Then, in T240, the management application 42 accepts the selection of the serial number SN1B in the above selection screen (“Accept Device Change” in S52 in FIG. 2). In this case, in T242, the management application 42 sends a status request to the printer 100B identified by the selected serial number SN1B (S22).

In T244, when the printer 100B receives the status request from the terminal 10 in T242, it sends status information to the terminal 10. In this case, the notification flag of the printer 100B indicates “ON”, thus the status information in T244 includes the notification flag “ON”.

In T244, the management application 42 receives the status information including the notification flag “ON” from the printer 100B (YES to S24, YES to S30). Based on the model name “MN1” included in the status information already received from the printer 100B, the management application 42 determines that the printer 100B has a display unit (YES to S32). In this case, the management application 42 generates a management screen SC3 including the notification button B3 (S40) and causes the display unit 14 to display the management screen SC3 in T250 (S50). In the management screen SC3, the serial number SN1B that has already been selected is described in the device selection object O1. Further, the remaining amount object O2 in the management screen SC3 indicates the remaining amount(s) of the coloring material(s) in the coloring material cartridge(s) installed in the printer 100B. Aside from other points, the management screen SC3 is the same as the management screen SC1. After that, the same processes as T40 to T66 in FIG. 4 are executed, and an email is sent to the administrator terminal 50 with a file attached that represents the status information of the printer 100B.

### (Case B-2; FIG. 5)

Next, Case B-2 in which the notification flag of the printer 100B indicates “OFF” will be described with reference to FIG. 5. Case B-2 is a continuation of FIG. 3. In Case B-2, the same processes as T230 to T242 are firstly performed. The printer 100B sends the status information to the terminal 10 in T254. In this case, the notification flag of the printer 100B indicates “OFF”, thus the status information in T254 includes the notification flag “OFF”.

In T254, the management application 42 receives the status information including the notification flag “OFF” from the printer 100B (YES to S24, NO to S30). In this case, the management application 42 generates a management screen SC4 that does not include the notification button B3 (S42), and causes the display unit 14 to display the management screen SC4 in T260 (S50). The management screen SC4 is the same as the management screen SC3 except that it does not include the notification button B3.

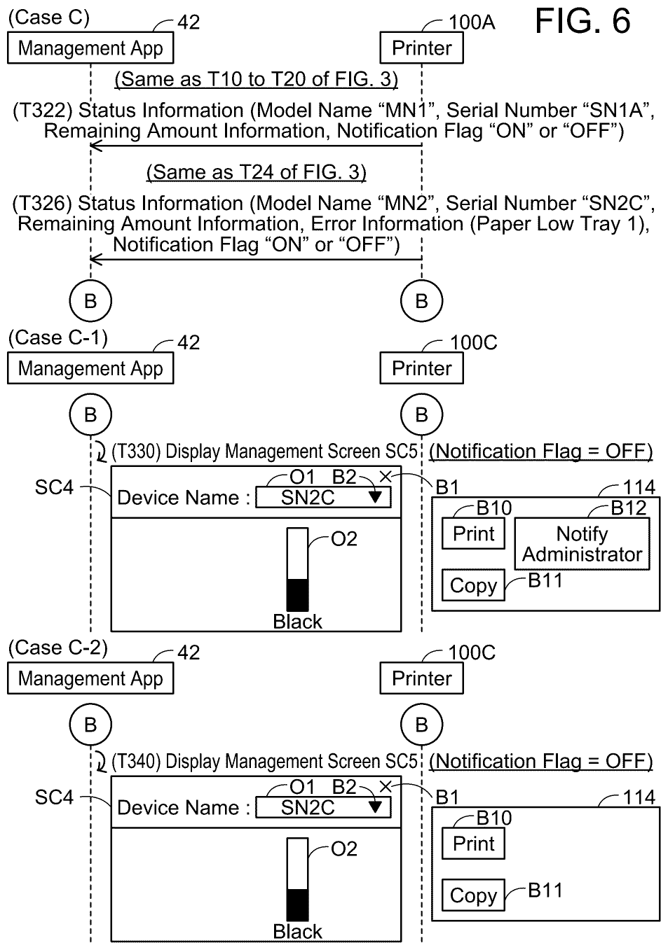

### (Case C; FIG. 6)

Next, Case C will be described with reference to FIG. 6. Case C is a case in which status information including error information is received from the printer 100C having the display unit 114. In Case C, firstly, the same processes as T10 to T20 in FIG. 3 are executed. The process in T322 is the same as the process in T22 in FIG. 3, except that the status information does not include error information. Further, a process the same as T24 in FIG. 3 is executed. Further, the process in T326 is the same as the process of T26 in FIG. 3, except that the status information includes error information.

### (Case C-1; FIG. 6)

Firstly, with reference to FIG. 6, Case C-1 in which the notification flag of the printer 100C indicates “ON” will be described. As shown in FIG. 6, the printer 100C causes the display unit 114 to display a screen including various buttons B10 to B12 under a state in which its power is ON. By selecting the print button B10 and designating image data representing a print target image to be printed, the user can cause the printer 100C to print the print target image. The user can also place a document on the printer 100C and select a copy button B11 to have the printer 100C copy the document.

Further, since the notification flag of the printer 100C indicates “ON”, the above screen includes the notification button B12. By selecting the notification button B12, the user can send (e.g., send an email including related information) related information related to the printer 100C to an external device (e.g., the administrator terminal 50).

In Case C-1, in T326, the management application 42 receives, from the printer 100C, the status information including error information and the notification flag “ON” (YES to S14 and YES to S30 in FIG. 2). Further, based on the model name “MN2” included in the status information already received from the printer 100C, the management application 42 determines that the printer 100C has a display unit (YES to S32). In this case, the management application 42 generates a management screen SC5 that does not include the notification button B3 (S42) and causes the display unit 14 to display the generated management screen SC5 in T330 (S50). In the management screen SC5, the serial number SN2C of the printer 100C, in which an error is occurring, is described in the device selection object O1. In addition, the remaining amount object O2 in the management screen SC5 indicates the remaining amount(s) of the coloring material(s) in the coloring material cartridge(s) installed in the printer 100C. Further, the management screen SC5 does not include the notification button B3.

As described above, the printer 100C having the display unit 114 causes the display unit 114 to display the screen including the notification button B12. For example, in a situation where an error is occurring in the printer 100C, the user can select the notification button B12 displayed on the printer 100C. That is, the user can notify the administrator even if a management screen including the notification button B3 is not generated by the management application 42. Therefore, the unnecessary button B3 is suppressed from being displayed.

### (Case C-2; FIG. 6)

Next, with reference to FIG. 6, Case C-2 in which the notification flag of the printer 100C indicates “OFF” will be described. In case C-2, in T326, the management application 42 receives the status information, from the printer 100C, including error information and the notification flag “OFF” (YES to S14 and NO to S30 in FIG. 2). In this case, the management application 42 generates a management screen SC5 that does not include the notification button B3 (S42) and causes the display unit 14 to display the generated management screen SC5 in T340 (S50).

### (Effects of Present Embodiment)

According to the above configuration, the management application 42 displays the management screen SC1 or SC2 (T30 or T130 in FIG. 4) in the case where it receives the information including the error information from the printer 100A (T22 in FIG. 3). Specifically, in the case where the notification flag indicates “ON” (Case A-1), the management application 42 displays the management screen SC1 including the notification button B3 (T30). Then, when the notification button B3 is operated by the user (T40), the management application 42 can supply a mailer activating instruction to the mailer 44 (T50) and cause the mailer 44 to send the email EM including the file F representing the status of the printer 100A (T60 to T66). On the other hand, in the case where the notification flag indicates “OFF” (Case A-2), the management application 42 displays the management screen SC2 which does not include the notification button B3 (T130). As such, a novel technique for sending status information of a printer (e.g., printer 100A) to an external device (e.g., the administrator terminal 50) is realized.

### (Corresponding Relationship)

The terminal 10 is an example of “terminal device”. The management application 42 and the mailer 44 are respectively examples of “computer-readable instructions” and “mailer program”. In Cases A-1, A-2, B-1, and B-2, the printer 100A is an example of “first communication device”. In Case C, the printer 100C is an example of “first communication device”. The printer 100B is an example of “second communication device”. The three printers 100A to 100C are examples of “a plurality of communication devices”. The three serial numbers SN1A to SN2C are examples of “a plurality of identification information”. The notification flag is an example of “flag information”. The notification flags “ON” and “OFF” are examples of “first value” and “second value,” respectively. The notification button B3 is an example of “first (and second) object”. The device selection object O1 and the remaining amount object O2 are examples of “selection object” and “status object”, respectively. The management screen SC1 displayed in T30 in FIG. 4 is an example of “first screen including a first object”. The management screen SC2 displayed in T130 in FIG. 4 is an example of “first screen not including the first object”. The file F representing the status of the printer 100A is an example of “related information related to the first communication device”. The management screen SC3 displayed in T250 in FIG. 5 is an example of “second screen including a second object”. The management screen SC4 displayed in T260 in FIG. 5 is an example of “second screen not including the second object”. The character string “Paper Low Tray 1” in the management screen SC1 is an example of “error information”. The model name “MN1” included in the status information of T22 in FIG. 3 is an example of “model information”. The model with the model name MN1 and the model with the model name MN2 are examples of “first model” and “second model”, respectively. In Case C, the management screen SC5 displayed in T330 in FIG. 6 is an example of “first screen not including the first object”. The process of T50 in FIG. 4 and the process of T50 in FIG. 4 mentioned in FIG. 5 are examples of “first process” and “second process”, respectively. The determination of YES to S14 or the determination of YES to S20 in FIG. 2 is an example of “predetermined condition is satisfied”.

The processes of S12 and S24 in FIG. 2 are examples of “obtain flag information”, “receive status information”, and “receive model information”. The process of S50 is an example of “cause a display unit of the terminal device to display a first screen (and cause the display unit to display a second screen)”. Especially, the process of T30 in FIG. 4 and the process of T130 are examples of “cause a display unit of the terminal device to display a first screen”, and the processes of T250 and T260 in FIG. 5 are examples of “cause the display unit to display a second screen”. The process of S54 in FIG. 2 is an example of “execute a first process”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(Modification 1) The status information sent from each of the printer 100A to 100C to the terminal 10 may not include a notification flag. In this case, for example, the management application 42 may store the notification flag of each of the printers 100A to 100C when each of the printers 100A to 100C is registered as a printer to be managed. The notification flag may be received from each printer or may be a value inputted by the user. In this modification, the process to obtain (i.e., receive or input) the notification flags when registering each of the printers 100A to 100C as the printer to be managed is an example of “obtain flag information”. In another modification, the communication system 2 may comprise a management server (not shown) that manages a plurality of printers including the printers 100A to 100C. The management application 42 may receive the notification flags for each of the printers 100A to 100C from that management server. In this modification, the process of receiving the notification flags from the management server is an example of “obtain flag information”.

(Modification 2) The information included in the file F attached to the e-mail is not limited to the respective information in the above embodiments. For example, the file F may include, in addition to or instead of the respective information in the above embodiments, operation log information or error information of the printers, or a combination thereof. The operation log information may include, for example, cumulative operating hours of the printer, a cumulative number of sheets printed, or a combination thereof. The error information may include, for example, paper jam, paper runout, coloring material runout, coloring material cartridge non-installation error, communication error, or a combination thereof. In this modification, the file F including these information is an example of “related information”. In another modification, the file F may include only a serial number. The administrator can recognize, for example, in which printer an error is occurring by looking at the file F. In this modification, the file including only the serial number is an example of “related information”.

(Modification 3) In the above embodiments, the management application 42 sends the status information to the administrator terminal 50 by executing the process for sending the email EM to which the file F representing the status information is attached. In a modification, the management application 42 may supply, to the mailer 44 in T50 in FIG. 4, the mailer activating instruction including the information that instructs the mailer 44 to write the status information in a body of the email, without generating the file F. As a result of this, the mailer 44 may send an email with the status written in the body of the email to the administrator terminal 50. Further, in another modification, the management application 42 may send the status information to the administrator terminal 50 according to a communication protocol such as HTTPS, for example. In this modification, the process of sending the status information to the administrator terminal 50 according to the communication protocol is an example of “first process”.

(Modification 4) The management screen (e.g., SC1) may not include the remaining amount object O2. In general terms, the “first screen” may not include “status object.” In this modification, “receive status information” may be omitted.

(Modification 5) The management screen (e.g., SC1) may not include the device selection object O1. In general terms, the “first screen” may not include “selection object”. In this modification, “cause the display unit to display a second screen” may be omitted.

(Modification 6) The management application 42 may omit the processes of S10 to S14 in FIG. 2. In this case, each of the printers to be managed may not receive a polling signal from the terminal 10 but autonomously send status information including error information to the terminal 10 when an error has occurred in the printer itself. When the management application 42 receives the status information including the error information from a printer, the management application 42 may determine that an error is occurring in the printer.

(Modification 7) The management application 42 may omit the process of S32 in FIG. 2. That is, the management application 42 may generate a management screen including the notification button B3 in the case where the notification flag of the target printer indicates “ON”, regardless of whether the target printer has a display unit or not. In this modification, the “receive model information” may be omitted.

(Modification 8) Even in the case where the target printer has a display unit (i.e., in the case of YES to S32 in FIG. 2), the management application 42 may generate a management screen including the notification button B3 when the display unit of the target printer is relatively small. That is, the management application 42 may generate a management screen that does not include the notification button B3 in a case where the target printer has a relatively large display unit, whereas the management application 42 may generate a management screen that includes the notification button B3 in the case where the target printer has a relatively small display unit or does not have a display unit. Here, a “relatively large display unit” means, for example, that the display unit of the target printer is large enough to display the notification button B12 (see FIG. 6). Further, a “relatively small display unit” means, for example, that the display unit of the target printer is not large enough to display the notification button B12 (see FIG. 6). For example, a specific example of the “relatively small display unit” may be an LCD panel that can only display one to two lines of text. In this modification, a model with a relatively small display unit is an example of “first model” and a model with a relatively large display unit is an example of “second model”.

(Modification 9) In the above embodiments, as shown in T22 in FIG. 3 for example, the management application 42 receives, from the printer 100A, the status information including the notification flag, remaining amount information, and model name “MN1” from the printer 100A. That is, in the above embodiments, the process of “obtain flag information”, the process of “receive status information”, and the process of “receive model information” were executed at a same timing. In a modification, these processes may be executed at different timings from each other.

(Modification 10) In the above embodiments, the processes of FIG. 2 to FIG. 6 are realized by software (e.g., OS 40, management application 42, mailer 44, program 144), however, at least one of these processes may be realized by hardware such as logic circuits.

What is claimed is:

1. A non-transitory computer-readable recording medium storing computer-readable instructions for a terminal device, the computer-readable instructions, when executed by a processor of the terminal device, causing the terminal device to:
obtain flag information related to a first communication device, wherein the flag information indicates either a first value or a second value;
in a case where a predetermined condition is satisfied, cause a display unit of the terminal device to display a first screen,
wherein in a case where the flag information related to the first communication device indicates the first value, the first screen including a first object related to the first communication device is displayed, and
in a case where the flag information related to the first communication device indicates the second value, the first screen not including the first object is displayed; and
in a case where the first object included in the first screen is operated by a user, execute a first process for sending related information related to the first communication device to an external device.

2. The non-transitory computer-readable recording medium as in claim 1, wherein
the computer-readable instructions, when executed by the processor, further cause the terminal device to:
receive status information indicating a status of the first communication device from the first communication device,
wherein in the case where the flag information related to the first communication device indicates the first value, the first screen including the first object and a status object indicating the status indicated by the status information is displayed, and
in the case where the flag information related to the first communication device indicates the second value, the first screen including the status object but not including the first object is displayed.

3. The non-transitory computer-readable recording medium as in claim 1, wherein
the first screen further includes a selection object for selecting one identification information from among a plurality of the identification information for identifying a plurality of communication devices including the first communication device, and
for each of the plurality of communication devices, the flag information related to the communication device is obtained,
wherein the computer-readable instructions, when executed by the processor, further cause the terminal device to:
in a case where identification information for identifying a second communication device different from the first communication device is selected from among the plurality of the identification information at the selection object included in the first screen, cause the display unit to display a second screen,
wherein in a case where the flag information related to the second communication device indicates the first value, the second screen including a second object related to the second communication device is displayed, and
in a case where the flag information related to the second communication device indicates the second value, the second screen not including the second object is displayed; and
in a case where the second object included in the second screen is operated by the user, execute a second process for sending related information related to the second communication device to an external device.

4. The non-transitory computer-readable recording medium as in claim 1, wherein
in a case where an occurrence of an error in the first communication device is detected, the predetermined condition is satisfied, and
the first screen includes error information indicating the error which occurred in the first communication device.

5. The non-transitory computer-readable recording medium as in claim 1, wherein
the computer-readable instructions, when executed by the processor, further cause the terminal device to:
receive model information indicating a model of the first communication device from the first communication device,
wherein in a case where the model information indicates a first model and the flag information related to the first communication device indicates the first value, the first screen including the first object is displayed, and
in a case where the model information indicates a second model different from the first model and the flag information related to the first communication device indicates the first value, the first screen not including the first object is displayed.

6. The non-transitory computer-readable recording medium as in claim 5, wherein
a communication device of the first model does not comprise a display unit, and
a communication device of the second model comprises a display unit.

7. The non-transitory computer-readable recording medium as in claim 1, wherein
the first process includes a process for causing a mailer program different from the computer-readable instructions to send an email including the related information related to the first communication device.

8. A method for controlling a terminal device, the method comprising:
obtaining flag information related to a first communication device, wherein the flag information indicates either a first value or a second value;
in a case where a predetermined condition is satisfied, causing a display unit of the terminal device to display a first screen,
wherein in a case where the flag information related to the first communication device indicates the first value, the first screen including a first object related to the first communication device is displayed, and
in a case where the flag information related to the first communication device indicates the second value, the first screen not including the first object is displayed; and
in a case where the first object included in the first screen is operated by a user, executing a first process for sending related information related to the first communication device to an external device.

9. The method as in claim 8, further comprising:
receiving status information indicating a status of the first communication device from the first communication device,
wherein in the case where the flag information related to the first communication device indicates the first value, the first screen including the first object and a status object indicating the status indicated by the status information is displayed, and
in the case where the flag information related to the first communication device indicates the second value, the first screen including the status object but not including the first object is displayed.

10. The method as in claim 8, wherein
in a case where an occurrence of an error in the first communication device is detected, the predetermined condition is satisfied, and
the first screen includes error information indicating the error which occurred in the first communication device.

11. The method as in claim 8, further comprising:
receiving model information indicating a model of the first communication device from the first communication device,
wherein in a case where the model information indicates a first model and the flag information related to the first communication device indicates the first value, the first screen including the first object is displayed, and
in a case where the model information indicates a second model different from the first model and the flag information related to the first communication device indicates the first value, the first screen not including the first object is displayed.

12. The method as in claim 11, wherein
a communication device of the first model does not comprise a display unit, and
a communication device of the second model comprises a display unit.

13. The method as in claim 8, wherein
the first process includes a process for causing a mailer program different from the computer-readable instructions to send an email including the related information related to the first communication device.

14. A terminal device comprising a controller,
wherein the controller is configured to:
obtain flag information related to a first communication device, wherein the flag information indicates either a first value or a second value;
in a case where a predetermined condition is satisfied, cause a display unit of the terminal device to display a first screen,
wherein in a case where the flag information related to the first communication device indicates the first value, the first screen including a first object related to the first communication device is displayed, and
in a case where the flag information related to the first communication device indicates the second value, the first screen not including the first object is displayed; and
in a case where the first object included in the first screen is operated by a user, execute a first process for sending related information related to the first communication device to an external device.

15. The terminal device as in claim 14, wherein
the controller is further configured to:
receive status information indicating a status of the first communication device from the first communication device,
wherein in the case where the flag information related to the first communication device indicates the first value, the first screen including the first object and a status object indicating the status indicated by the status information is displayed, and
in the case where the flag information related to the first communication device indicates the second value, the first screen including the status object but not including the first object is displayed.

16. The terminal device as in claim 14, wherein
in a case where an occurrence of an error in the first communication device is detected, the predetermined condition is satisfied, and
the first screen includes error information indicating the error which occurred in the first communication device.

17. The terminal device as in claim 14, wherein
the controller is further configured to:
receive model information indicating a model of the first communication device from the first communication device,
wherein in a case where the model information indicates a first model and the flag information related to the first communication device indicates the first value, the first screen including the first object is displayed, and
in a case where the model information indicates a second model different from the first model and the flag information related to the first communication device indicates the first value, the first screen not including the first object is displayed.

18. The terminal device as in claim 17, wherein
a communication device of the first model does not comprise a display unit, and
a communication device of the second model comprises a display unit.

19. The terminal device as in claim 14, wherein
the first process includes a process for causing a mailer program different from the computer-readable instructions to send an email including the related information related to the first communication device.
